(19) United States
(12) Patent Application Publication
(10) Pub. No.: US 2024/0157578 A1
(43) Pub. Date: May 16, 2024

(54) Electrode Lead Gripper

(71) Applicant: LG Energy Solution, Ltd., Seoul (KR)

(72) Inventor: Myung Bin Kwon, Daejeon (KR)

(73) Assignee: LG Energy Solution, Ltd., Seoul (KR)

(21) Appl. No.: 18/283,914

(22) PCT Filed: Sep. 27, 2022
(86) PCT No.: PCT/KR2022/014467

§ 371 Date: Sep. 25, 2023

(30) Foreign Application Priority Data
Sep. 29, 2021 (KR) 10-2021-0129232

(51) Int. Cl. B25J 15/00; H01M 50/564

(52) U.S. Cl. CPC B25J 15/0033; H01M 50/564

(57) ABSTRACT

The present invention relates to a lead transport gripper that is capable of stably transporting an electrode lead, without twisting the electrode leads due to friction or pressure.

### CROSS-REFERENCE TO RELATED APPLICATIONS

This application is a national stage entry under 35 U.S.C. § 371 of International Application No. PCT/KR2022/014467, filed on Sep. 27, 2022, which claims priority to Korean Patent Application No. 10-2021-0129232, filed on Sep. 29, 2021, the entire disclosures of which are hereby incorporated herein by reference.

### TECHNICAL FIELD

The present invention relates to an electrode lead gripper.

### BACKGROUND ART

Demand for high-efficiency secondary batteries is rapidly increasing in the fields of mobile devices and electric vehicles. Among such secondary batteries, lithium secondary batteries, which have high energy density, can maintain relatively high voltage, and have a low self-discharge rate, have been commercialized and widely used, and research and development for improving performance are being actively performed.

The lithium secondary batteries can be classified into a lithium ion battery that uses a liquid electrolyte, and a lithium ion polymer battery that uses a polymer solid electrolyte depending on the type of electrolyte.

In the case of the lithium ion battery that uses a liquid electrolyte, it may be usually used in the form in which a cylindrical or rectangular metal can is used as a container and is welded and sealed. Since the can-type secondary battery that uses such a metal can as a container has a fixed shape, it has the drawback of restricting the design of electronic products that uses it as a power source, and it is difficult to reduce the volume. Therefore, a pouch-type secondary battery has been developed and used in which both electrodes, a separation membrane, and an electrolyte are formed into a film, put in a pouch, and sealed.

The pouch-type secondary battery includes, as a basic structure, a battery case and an electrode assembly which are made up of a pouch or the like.

The electrode assembly includes a positive electrode plate, a negative electrode plate, and a separation membrane interposed between the positive electrode plate and the negative electrode plate to electrically insulate the positive electrode plate and the negative electrode plate.

As shown in FIG. 1, in an electrode assembly 10, the positive elecrode plate is provided with an anode tab 12 provided on one or more regions of the positive electrode plate, and the negative electrode plate is provided with a negative electrode tab 13 provided on one or more regions of the negative electrode plate. After the one or more positive electrode tabs 12 and negative electrode tabs 13 converge in a certain direction, they are joined to the electrode lead 20 made of a conductive material by a method such as general resistance welding, ultrasonic welding, laser welding, and riveting. At this time, a sealing film 21 may be disposed around the electrode lead 20 to ensure an insulated state at a contact portion with the battery case and to increase the degree of sealing.

The electrode lead 20 connected and extending in this way performs a function corresponding to a predetermined electrode interface for electrically connecting the secondary battery and an external application device.

In order to bond the electrode lead 20 to the electrode tabs 12 and 13, the electrode lead 20 needs to be transported so as to be located above the electrode tabs 12 and 13. The electrode lead 20 is transported using a type of gripping and transporting the electrode lead 20 by the gripper 200, and is a type of applying pressure to the electrode lead 20 with the gripper 200 to fix the electrode lead 20 and transporting it to the electrode tabs 12 and 13 of the electrode assembly 10.

FIG. 2 is a side cross-sectional view showing that the gripper 210 grips the electrode lead 20 in the above-described conventional manner, and in which the electrode lead 20 having a flat surface is gripped using the gripper 200 having a flat grip surface.

However, if the electrode lead 20 and the grip surface are flat as described above, when a change occurs in pressure or surface friction, a phenomenon in which the electrode lead 20 is twisted as shown in FIG. 3 may occur, which may cause dimensional defects in the battery.

Therefore, there is an emerging need for an electrode lead gripper that can solve the above problems.

### PRIOR ART DOCUMENT

### Patent Document

Korean Patent Application No. 10-2014-0133140

Korean Patent Application No. 10-2012-0016905

### DISCLOSURE

### Technical Problem

An object of the present invention is to provide an electrode lead gripper that can transport the electrode lead gripper without twisting the electrode lead, even if pressure or friction changes, by fixing the electrode lead using a gripper.

### Technical Solution

In order to achieve the above purpose,
the present invention provides a lead gripper that grips and transports an electrode lead,
wherein the lead gripper includes an upper arm and a lower arm,
wherein one or more grip surfaces of any one of the upper arm and the lower arm include one or more lead fixing protrusions that pass through the electrode lead to be gripped.

In an aspect of the present invention, the grip surface of the upper arm or the lower arm corresponding to the upper arm or the lower arm including the lead fixing protrusion may include a groove which accommodates the lead fixing protrusion.

In an aspect of the present invention, the lead fixing protrusion may pass through the electrode lead and may be inserted into the groove which accommodates the lead fixing protrusion.

In an aspect of the present invention, the lead fixing protrusion may have a truncated conical shape or a truncated polygonal pyramid shape.

In an aspect of the present invention, the lead fixing protrusion may have the truncated conical shape.

In an aspect of the present invention, the two or more lead fixing protrusions may be included, and the two or more lead fixing protrusions may be located on the grip surface to be spaced apart from each other.

In an aspect of the present invention, the two or more lead fixing protrusions may be located in a horizontal direction or in a vertical direction on the basis of a tip of the arm.

In an aspect of the present invention, the lead gripper may include one to three pairs of arms.

In an aspect of the present invention, the lead gripper may transport the electrode lead including one or more lead fixing holes.

In an aspect of the present invention, the lead fixing hole may have a circular or polygonal shape.

In an aspect of the present invention, the lead fixing hole may have a circular shape.

In an aspect of the present invention, the lead gripper may include a pair of arms,
the grip surface of any one of the upper arm or the lower arm may include two or more lead fixing protrusions that pass through the gripped electrode lead,
the two or more lead fixing protrusions may be located in the horizontal direction or in the vertical direction on the basis of the tip of the arm, and
the grip surface of the upper arm or the lower arm corresponding to the upper arm or the lower arm including the lead fixing protrusion may include a groove that accommodates the lead fixing protrusion.

In an aspect of the present invention, the lead gripper may include two or more pairs of arms,
the grip surface of any one of the upper arm or the lower arm in each pair of arms may include one or more lead fixing protrusions that pass through the gripped electrode lead, and
the grip surface of the upper arm or the lower arm corresponding to the upper arm or the lower arm including the lead fixing protrusion in each pair of arms may include a groove that accommodates the lead fixing protrusion.

### Advantageous Effects

Since the lead gripper of the present invention can fix the electrode lead by the lead fixing protrusion that passes through the electrode lead, it is possible to grip and transport the electrode lead without twisting the electrode lead even when pressure and friction change. This makes it possible to solve problems such as dimensional defects of the battery.

### DESCRIPTION OF DRAWINGS

FIG. 1 is a perspective view of an electrode assembly.

FIG. 2 is a side sectional view showing a status in which a conventional electrode lead gripper grips the electrode lead.

FIG. 3 is a plan view showing a lead twisting phenomenon that occurs in the conventional electrode lead transportation.

FIG. 4 is a side cross-sectional view of a lead gripper according to an embodiment of the present invention.

FIG. 5 is a front view of a lead gripper according to an embodiment of the present invention.

FIG. 6 is a plan view of the electrode lead gripped by the lead gripper according to an embodiment of the present invention.

FIG. 7 is a plan view of the electrode lead gripped by the lead gripper according to an embodiment of the present invention.

FIG. 8 is a plan view of the lead gripper that grips the electrode lead according to an embodiment of the present invention.

FIG. 9 is a plan view of the lead gripper that grips the electrode lead according to an embodiment of the present invention.

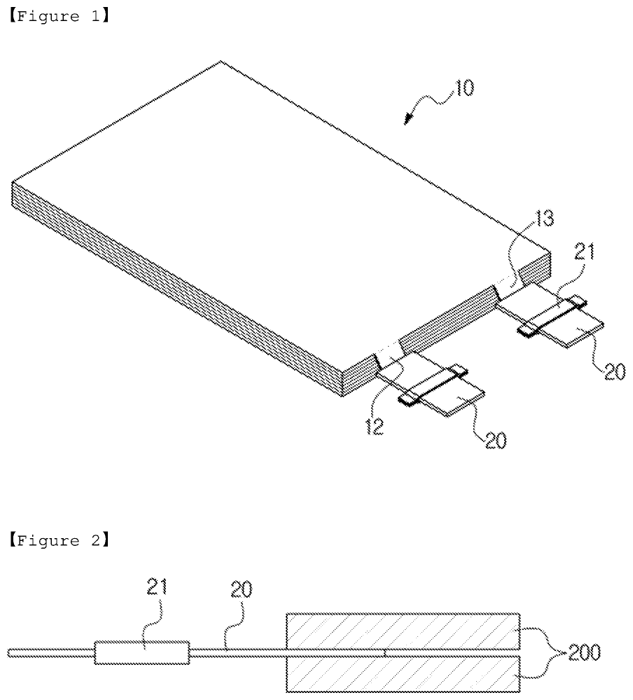

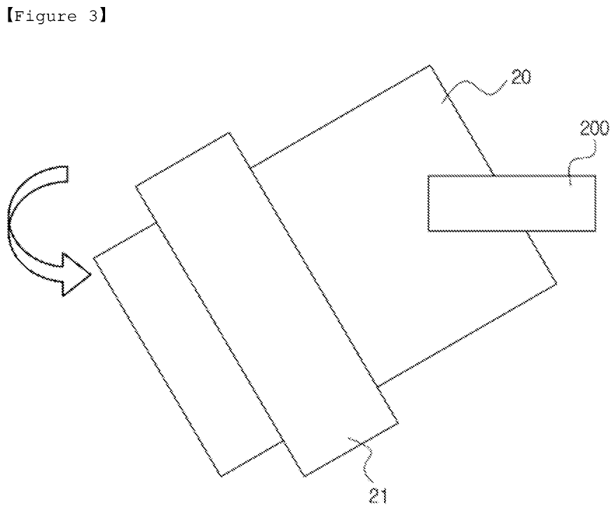

### BEST MODE

Hereinafter, the present invention will be described in detail based on the accompanying drawings so that a person having ordinary knowledge in the technical field to which the present invention belongs can easily carry it out. This invention may, however, be embodied in many different forms and is not limited to the embodiments set forth herein.

In order to clearly describe the present invention, parts irrelevant to the description have been omitted, and the same or similar components are denoted by the same reference numerals throughout the specification.

Furthermore, terms or words used in the specification and claims should not be construed as being limited to its customary or dictionary meaning, and should be interpreted by the inventors as a meaning and concept consistent with the technical idea of the present invention, based on the principle that the concepts of the terms can be properly defined to describe their invention in the best possible manner.

Embodiments will now be described in detail with reference to the accompanying drawings. This invention may, however, be embodied in many different forms and is not limited to the embodiments set forth herein.

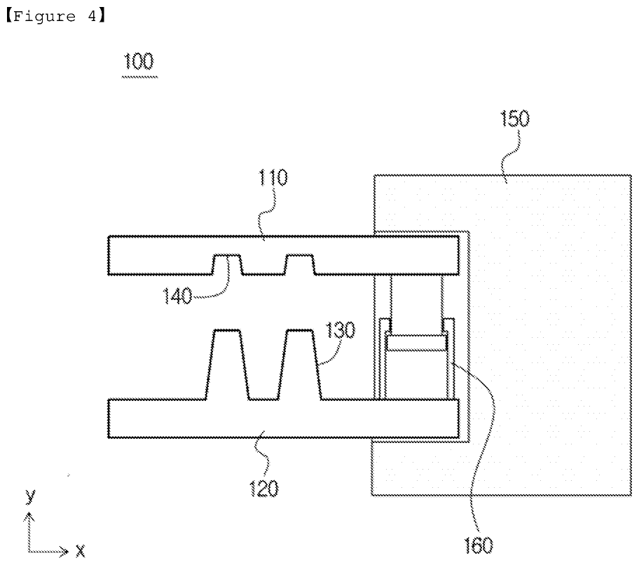

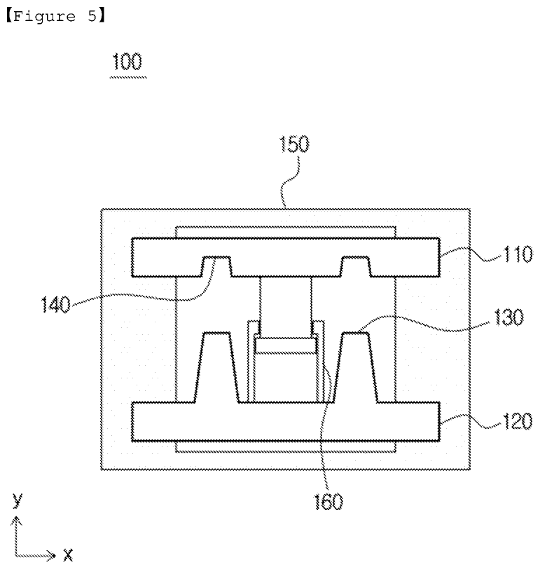

FIGS. 4 and 5 are side cross-sectional views that show a lead gripper according to an embodiment of the present invention.

Referring to FIGS. 4 and 5, a lead gripper 100 according to one embodiment of the present invention includes an upper arm 110 and a lower arm 120, and any one or more grip surfaces of the upper arm 110 and the lower arm 120 may include one or more lead fixing protrusions 130 that pass through the electrode lead to be gripped.

Also, the grip surface of the upper arm 110 or the lower arm 120 corresponding to the upper arm 110 or the lower arm 120 including the lead fixing protrusion 130 may include grooves 140 that accommodate the lead fixing protrusion 130.

In the lead gripper 100 of the present invention, other configurations except for the structure of the gripper 100 can be configured in the same manner as lead grippers commonly used in this field. That is, as shown in FIG. 4, rear end portions of the upper arm 110 and the lower arm 120 can be coupled to a lead gripper body 150. At this time, the lead gripper body 150 may include an arm moving member 160 that moves one or more of the upper arm 110 and the lower arm 120 to enable gripping. The arm moving member 160 can be driven by known driving means, for example, hydraulic driving means, mechanical driving means, or the like.

In the lead gripper 100 of the present invention, the lead fixing protrusion 130 can be inserted through the electrode lead into the groove 140 that accommodates the lead fixing protrusion 130. That is, the upper end portion of the lead fixing protrusion 130 can be inserted into the groove 140 that accommodate the lead fixing protrusion, while penetrating the electrode lead.

For example, when the lower arm 120 includes the lead fixing protrusion 130, and the upper arm 110 includes the groove 140 for accommodating the lead fixing protrusion 130, the electrode lead can be grasped by fitting engagement in which the lower arm 120 moves upward so that the lead fixing protrusion 130 passes through the electrode lead, and the upper arm 110 moves downward to insert the penetrated lead fixing protrusion 130 into the groove 140. Also, the electrode lead grip can be released by moving the lower arm 120 downward and moving the upper arm 110 upward to release the fitting engagement.

Due to the fitting engagement, the electrode lead can be transported to the electrode tab of the electrode assembly without being twisted.

The lead fixing protrusion 130 may have a truncated conical shape or a truncated polygonal pyramid shape.

If the lead fixing protrusion 130 has a truncated polygonal pyramid shape, since the lead is less likely to be twisted due to the polygonal shape, one or more lead fixing protrusions 130 may be included on the grip surface of the upper arm 110 or the lower arm 120.

In addition, when the lead fixing protrusion 130 has a truncated conical shape, since the penetrated lead fixing protrusion 130 is easily twisted, two or more lead fixing protrusions 130 may be included on the grip surface of the upper arm 110 or the lower arm 120.

Preferably, two or more lead fixing protrusions 130 may be included on the grip surface of the upper arm 110 or the lower arm 120, and the two or more lead fixing protrusions may be spaced apart from each other on the grip surface.

FIG. 4 is a diagram showing that the two or more lead fixing protrusions 130 are located in a horizontal direction x on the basis of the tip of the arm, and FIG. 5 shows that the two or more lead fixing protrusions 130 are located in a vertical direction y.

The lead gripper 100 may include one to three pairs of arms.

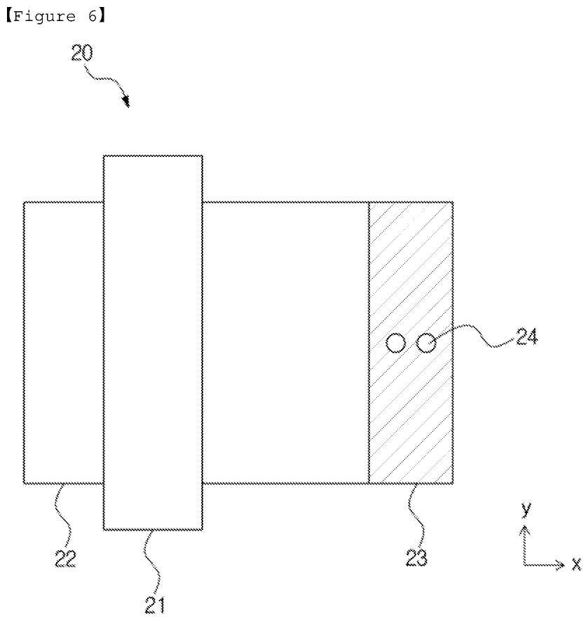

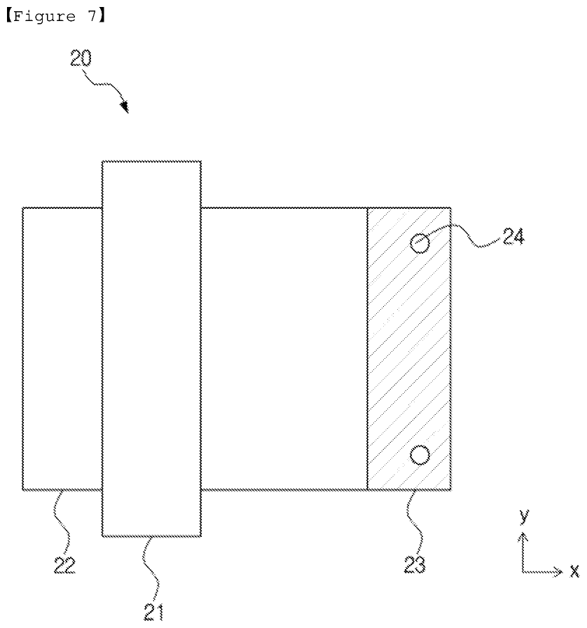

FIGS. 6 and 7 are plan views showing the electrode lead 20 that is gripped by the lead gripper 100 according to an embodiment of the present invention.

In order for the lead fixing protrusion 130 of the lead gripper 100 to pass through the electrode lead 20, the electrode lead 20 may include a lead fixing hole 24 through which the lead fixing protrusion 130 can pass. Specifically, one or more lead fixing holes 24 may be included.

Referring to FIGS. 6 and 7, the electrode lead 20 includes a joint portion 22 joined with the electrode tab, and one or more lead fixing holes 24 at one end portion, and a sealing film 21 can be placed around the electrode lead 20.

The grip of the electrode lead 20 can be performed by making the lead fixing protrusion 130 pass through the lead fixing hole 24 formed in the electrode lead, and by inserting the lead fixing protrusion 130 having passed through the lead fixing hole 24 into the groove 140 that accommodates the lead fixing protrusion.

For example, when the lower arm 120 includes the lead fixing protrusion 130 and the upper arm 110 includes the groove 140 that accommodates the lead fixing protrusion 120, the electrode lead 20 can be gripped by the fitting engagement in which the lower arm 120 moves upward to allow the lead fixing protrusion 130 to pass through the lead fixing hole 24 of the electrode lead 20, and the upper arm 110 moves downward to insert the lead fixing protrusion 130 having passed through the lead fixing hole 24 into the groove 140. Further, the grip of the electrode lead 20 can be released, by moving the lower arm 120 downward and moving the upper arm 110 upward to release the fitting engagement.

After the electrode lead 20 is gripped, it may be transported such that the joint portion 22 of the gripped electrode lead can be located above the electrode tab. After the transportation is completed and the grip of the electrode lead 20 is released, since the lead fixing hole 24 of the electrode lead 20 is no longer needed, it is possible to perform a step of cutting one end portion of the electrode lead 20 at which the lead fixing hole 24 is located. Cutting can be performed along a cut surface 23 of the electrode lead 20.

The lead fixing hole 24 may have a circular or polygonal shape, and the shape of the lead fixing hole 24 can be determined depending on the shape of the lead fixing protrusion 130. Preferably, lead fixing hole 24 may have a circular shape.

Also, the lead fixing holes 24 may be included in the same number as the lead fixing protrusions 130, and two or more lead fixing holes 24 may be located at one end portion of the electrode lead 20 to be separated from each other.

FIG. 6 is a diagram showing that the two or more lead fixing holes 24 are located in the horizontal direction x on the basis of the tip of the electrode lead 20, and FIG. 7 is a diagram showing that the two or more lead fixing holes 24 are located in the vertical direction y.

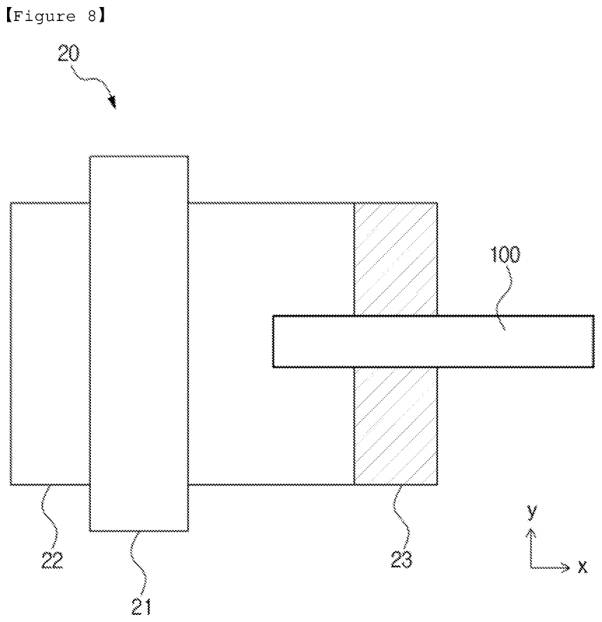

FIG. 8 shows that the lead gripper 100 according to one embodiment of the present invention grips the electrode lead 20.

Referring to FIG. 8, the lead gripper 100 according to an embodiment of the present invention can include a pair of arms. Additionally, the grip surface of one of the upper arm 110 or the lower arm 120 can include two or more lead fixing protrusions 130 that pass through the gripped electrode lead 20. The two or more lead fixing protrusions 130 may be located in the horizontal direction x or in the vertical direction y on the basis of the tip of the arm. Also, a groove 140 that accommodates the lead fixing protrusion 130 can be included on the grip surface of the upper arm 110 or the lower arm 120 corresponding to the upper arm 110 or the lower arm 120 including the lead fixing protrusion 130.

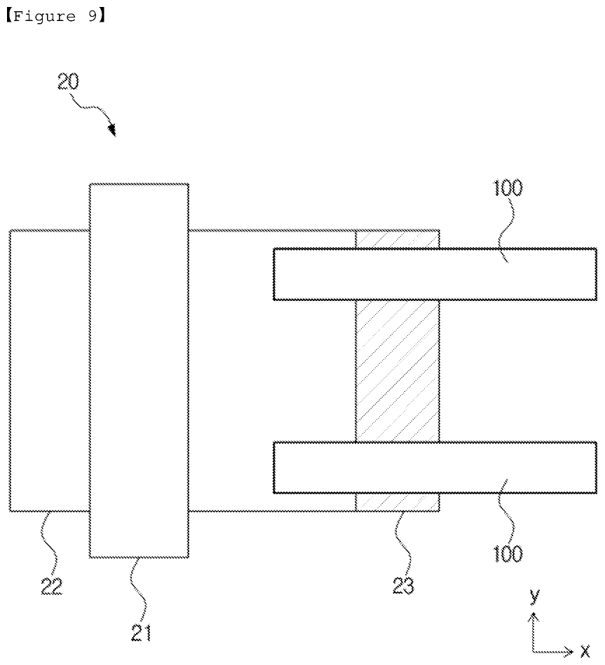

FIG. 9 shows a lead gripper 100 according to an embodiment of the present invention.

Referring to FIG. 9, a lead gripper 100 according to one embodiment of the present invention can include two pairs of arms. The grip surface of either upper arm 110 or lower arm 120 in each pair of arms can include one or more lead fixing protrusions 130 that pass through the electrode lead 20 being gripped. At this time, the grip surface of the upper arm 110 or the lower arm 120 corresponding to the upper arm 110 or the lower arm 120 including the lead fixing protrusion 130 in each pair of arms may include a groove 140 that accommodates the lead fixing protrusion.

Various modifications and variations may be made without departing from the spirit and scope of the present invention. Accordingly, the appended claims shall include such modifications or variations insofar as they fall within the spirit of the present invention.

### DESCRIPTION OF SYMBOLS

10: Electrode assembly, 12: Positive electrode tab
13: Negative electrode tab 20: Electrode lead
21: Sealing film, 22: Joint portion
23: Cut surface, 24: Lead fixing hole
100, 200: Lead gripper, 110: Upper arm
120: Lower arm, 130: Lead fixing protrusion
140: Groove, 150: Lead gripper body
160: Ann moving member

1. A lead gripper configured to grip and transport an electrode lead, the lead gripper comprising:
an upper arm and a lower arm together configured to grip the electrode lead,
wherein one or more grip surfaces of a first one of the upper arm or the lower arm comprise one or more lead fixing protrusions that are each configured to pass through the electrode lead.

2. The lead gripper according to claim 1, wherein a grip surface of a second one of the upper arm or the lower arm comprises one or more grooves configured to accommodate the one or more lead fixing protrusions therein.

3. The lead gripper according to claim 2, wherein the one or more lead fixing protrusions each are configured to pass through the electrode lead and be inserted into the one or more grooves.

4. The lead gripper according to claim 1, wherein the one or more lead fixing protrusions each have a truncated conical shape or a truncated polygonal pyramid shape.

5. The lead gripper according to claim 4, wherein the one or more lead fixing protrusions each have the truncated conical shape.

6. The lead gripper according to claim 1, wherein the one or more lead fixing protrusions are two or more lead fixing protrusions, and the two or more lead fixing protrusions are located on one of the grip surfaces spaced apart from each other.

7. The lead gripper according to claim 6, wherein the two or more lead fixing protrusions are spaced apart from each other in a horizontal direction or in a vertical direction.

8. The lead gripper according to claim 1, wherein the upper arm and the lower arm are a first pair of arms, and the lead gripper further comprises one or two additional pairs of arms.

9. The lead gripper according to claim 1, wherein the lead gripper is configured to transport the electrode lead, and the electrode lead comprises one or more lead fixing holes.

10. The lead gripper according to claim 9, wherein the one or more lead fixing holes each have a circular or polygonal shape.

11. The lead gripper according to claim 10, wherein the one or more lead fixing holes each have a circular shape.

12. The lead gripper according to claim 1, wherein the one or more lead fixing protrusions are two or more lead fixing protrusions that are each configured to pass through the electrode lead,
the two or more lead fixing protrusions are spaced apart from each other in a horizontal direction or a vertical direction, and
the one or more grooves are two or more grooves that accommodate the two or more lead fixing protrusions therein.

13. The lead gripper according to claim 1, wherein the upper arm and the lower arm are a first pair of arms, and the lead gripper further comprises one or more additional pairs of arms,
one or more grip surfaces of a first one of the upper arm or the lower arm of each additional pair of arms comprises one or more lead fixing protrusions that are each configured to pass through the electrode lead, and
a grip surface of a second one of the upper arm or the lower arm of each additional pair of arms comprises a groove that is configured to accommodate the one or more lead fixing protrusions therein.

14. A method of gripping an electrode lead with a lead gripper, the method comprising:
passing one or more lead fixing protrusions of the lead gripper through the electrode lead; and
gripping the electrode lead between an upper arm and a lower arm of the lead gripper, one or more grip surfaces of a first one of the upper arm or the lower arm comprising the one or more lead fixing protrusions.

15. The method according to claim 14, wherein a grip surface of a second one of the upper arm or the lower arm comprises one or more grooves that accommodates the one or more lead fixing protrusions therein.

16. The method according to claim 15, further comprising inserting the one or more lead fixing protrusions into the one or more grooves.

17. The method according to claim 14, wherein the one or more lead fixing protrusions are two or more lead fixing protrusions, and the two or more lead fixing protrusions are located on one of the grip surfaces spaced apart from each other.

18. The method according to claim 17, wherein the two or more lead fixing protrusions are spaced apart from each other in a horizontal direction or in a vertical direction.

19. The method according to claim 14, wherein the upper arm and the lower arm are a first pair of arms, and the lead gripper further comprises one or two additional pairs of arms, the gripping further comprising gripping the electrode lead between an upper arm and a lower arm of each of the one or two additional pairs of arms.

20. The method according to claim 14, wherein the passing comprises passing the one or more lead fixing protrusions through one or more lead fixing holes extending through the electrode lead, the method further comprising transporting the electrode lead with the lead gripper.
